(19) United States
(12) Patent Application Publication
(10) Pub. No.: US 2024/0348689 A1
(43) Pub. Date: Oct. 17, 2024

(54) System, Method and Apparatus for Communication with Occupants of a Vehicle

(71) Applicant: Eddie B. Lofton, Grayson, GA (US)

(72) Inventor: Eddie B. Lofton, Grayson, GA (US)

(21) Appl. No.: 18/738,080

(22) Filed: Jun. 10, 2024

Related U.S. Application Data
(63) Continuation-in-part of application No. 18/149,171, filed on Jan. 3, 2023.

(51) Int. Cl. H04L 67/125; G06Q 50/26; H04W 4/029

(52) U.S. Cl. CPC H04L 67/125; G06Q 50/265; H04W 4/029

(57) ABSTRACT

A system and method for communicating between an official and an end-user includes a way to determine when any end-user is within a preset distance of the official and a way to display each of the any end-users that is/are within the preset distance of the official on a display that is visible to the official, and a way to initiate a call from the official to any one of the any end-users that is/are within the preset distance of the official.

### FIELD OF THE INVENTION

This invention relates to the field of communications and more particularly to a system for communicating with an occupant of a vehicle.

### BACKGROUND OF THE INVENTION

There are many needs for communicating with an occupant of a vehicle, car, bus, truck, etc. Examples of such are to initiate a transaction at a drive through window, answering questions at a roadblock or checkpoint, during a traffic stop, etc. Currently, to perform such communications requires that an occupant of the vehicle open a window or door and communicate through that open window or door.

Often, a stranded motorist or a witness to an accident will call an emergency number (e.g., e911) to request help. The call is usually answered by a call center and after obtaining information from the caller, help is dispatched, for example, an officer or a road warrior is dispatched to the location of the stranded motorist or accident. In the past, once the call for help is disconnected, the motorist (or witness) does not have further contact with the dispatched help until the officer or road warrior (responder) arrives at the scene. Often there is a need to provide voice contact between the caller and the officer or road warrior while they travel to the scene, for example, so the responder is able to gather further information regarding the issue of comfort the caller. Further, for safety reasons, it is desired that the responder be in voice communication with the caller upon arrival at the scene to survey the level of safety for the responder before exiting of the responder's vehicle. Further, in certain climates, weather makes it uncomfortable and inconvenient for the caller to open their window or for the responder to leave the responder's vehicle.

There are existing ways to perform communications between the caller and the responder, none of which are practical. For example, a cellular phone can be used to establish a voice call with the occupant. This is not practical because there is no established protocol for conveying the caller's phone number to a responder or visa versa and such may be a violation of privacy to either the caller or to the responder. From a privacy point of view, many first responders do not wish others to know their cellular phone number which may be a cause for unwanted phone calls.

Further, there exists a need for communications and privacy when an office notices a stranded motorist. For example, when an office (or road ranger) is traveling down a road and notices a stranded motorist or an officer pulls someone over for a traffic violation, it is often important to communicate with the motorist to discover if help is needed. In the past, the officer (or road ranger) would pull behind the motorist, leave their car and approach the motorist to talk with the motorist. This is not only dangerous for the officer, as there is a risk of being struck by another motorist or any known danger from within the vehicle, but also causes the officer to exit their vehicle in many types of weather, including when lightning is present. It would be far better if the officer (or road ranger) had the ability to communicate with the stranded motorist without exiting their vehicle to appraise the situation and arrange appropriate help. As discussed, it is also desirable that, after the communications are completed, the contact information of both the motorist and the officer (or road ranger) remain private.

Further, when an officer pulls someone over for a traffic stop, there is some amount of danger when the officer approaches the stopped vehicle, both to the officer and to the motorist that has been pulled over. There is danger to the motorist as the officer has a weapon and may discharge that weapon should the officer sense danger from a certain action of the motorist or other occupant of the vehicle. Likewise, many officers are injured or killed upon pulling over a motorist, often hit by another vehicle.

What is needed is a system that will enable two-way voice communication between the motorist and the officer/road warrior without requiring disclosure of either the motorist's contact information or the officer's/road warrior's contact information.

### SUMMARY OF THE INVENTION

Users will have the ability to load an application (herein referred to as the safetalk-connect application) onto their device (e.g., any processor-based device having a location service such as GPS, including, but not limited to, a smartphone, a personal computer, a computer integrated into a vehicle, a tablet computer, a smartwatch, a smart dashcam). Once loaded, configured, and running, the safetalk-connect application periodically reports the location of the device to a server. An authorized user such as an officer or road ranger has a second device (herein referred to as the officer device) running another application (herein referred to as the webhost application application). The webhost application periodically sends the location of the officer device (e.g., the location of the officer or road ranger) to the same server. Periodically, the server compares the locations of all active devices (e.g., smartphones of motorists, passengers, or pedestrians) to all active officer devices and, for each device that is within a specified distance (e.g., 1000 feet) of an officer device, the location of the device (e.g., the motorist or end user) is sent to the webhost application of that officer device and displayed at the officer device (e.g., in text format and/or on a map). When the officer selects this particular device (e.g., an icon of the motorist), a voice and/or video call is made between the officer device and the device of the end user (e.g. through the phone system, cellular system, or any wireless communications). Upon the motorist answering the call, the officer is able to communicate with the motorist by voice and/or video.

Note that the scenario described above is between an officer/road ranger and a motorist, but other scenarios are anticipated and included here within. For one example, the scenario described above is between an officer/road ranger and a passenger in a vehicle that has a smartphone with the safetalk connect application. In another example, for restaurants, banks, etc., in that when a user (motorist) is within range of an establishment (e.g., restaurant), information of the user is displayed on the second device within the restaurant and a user within the restaurant is able to connect to the second device, for example, when the user is in a drive thru lane. Other examples include late-night stores, users walking through a mall, welfare checking, schools, etc.

In one embodiment, a system for communicating between an official and an end-user includes an officer device associated with the official. The officer device has a processor, a display, a memory, a global positioning subsystem, and a first network interface for connecting to a wide area network. An end-user device has an end-user processor, an end-user display, a second network interface for connecting to the wide area network, an end-user global positioning subsystem, and an end-user memory that has a safetalk-connect application installed therein. A safetalk server computer has a server processor, server memory, and a third network interface for connecting to the wide area network. Periodically, a webhost application running on the officer device reads the global positioning subsystem and transmits the location of the officer device to the safetalk server computer. Similarly, periodically, the safetalk-connect application running on the end-user device reads the end-user global positioning subsystem and transmits the location of the end-user device to the safetalk server computer. When the safetalk server computer receives the location from either the officer device or the end-user device, software running on the safetalk server computer adds a record to a table of locations. Periodically, the safetalk server computer calculates a distance between the officer device and the end-user devices and for each end-user device that is within a preset distance from the officer device, the location of the end-user device is displayed on the display of the officer device.

In another embodiment, a system for communicating between officials and end-users includes a plurality of officer devices. Each officer device associated with one of the officials and each of the officer devices has a processor, a display, a memory, a global positioning subsystem, and a first network interface for connecting to a wide area network. A plurality of end-user devices, each has an end-user processor, an end-user display, a second network interface for connecting to the wide area network, an end-user global positioning subsystem, and an end-user memory with a safetalk-connect application installed in the end-user memory and running on the end-user processor. A safetalk server computer has a server processor, server memory, and a third network interface for connecting to the wide area network. Periodically, a webhost application running on each of the officer devices reads the global positioning subsystem and transmits a location of the officer device to the safetalk server computer over the wide area network. Periodically, the safetalk-connect application running on each of the end-user devices reads the end-user global positioning subsystem and transmits the location of the end-user device to the safetalk server computer over the wide area network. When the safetalk server computer receives the location from either the officer device or the end-user device from the wide area network, software running on the safetalk server computer adds a record to a table of locations. Periodically, for each officer device of the officer devices, software running on the server processor calculates a distance between the each officer device and each of the end-user devices and for each end-user device that is within a preset distance from the officer device, the location of the each end-user device is saved in a list and the list is transmitted from the safetalk server computer to the each officer device over the wide area network and displayed on the display of the each officer device.

In another embodiment, a method for communicating between an official and an end-user includes a way to determine when any end-user is within a preset distance of the official and a way to display each of the any end-users that is/are within the preset distance of the official on a display that is visible to the official, and a way to initiate a call from the official to any one of the any end-users that is/are within the preset distance of the official.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a plan view illustrating a system for communicating between a responder and a caller (e.g., a person requesting assistance).

FIG. 2 illustrates communication equipment in vehicles of the system for communicating between a responder and a caller.

FIG. 3 illustrates communications between the responder and caller in the system for communicating between a responder and a caller.

FIG. 4 illustrates an exemplary device used by a caller to initiate a call for help or for a responder to communicate during a response.

FIG. 5 illustrates an exemplary computer system used by a call center to process a call for help and dispatch a responder.

FIGS. 6-8 illustrate exemplary user interfaces of the system for communicating between a responder and a caller.

FIGS. 9 and 10 illustrate sample program flows of the system for communicating between a responder and a caller.

FIGS. 11 and 12 illustrate communications between a webhost application (e.g., associated with the official), a safetalk-connect application (e.g., associated with an end user 12) and a server.

FIG. 13 illustrates an exemplary registration user interface.

FIG. 14 illustrates communications between a webhost application (e.g., associated with the official), a safetalk-connect application (e.g., associated with an end user 12), a supervisor's device, and a server.

FIG. 15 illustrates a scenario in which an official vehicle is within the preset distance (e.g., within 1000 feet) of two vehicles.

FIG. 16 illustrates a scenario in which an official vehicle has pulled over a vehicle for a traffic stop.

FIG. 17 illustrates a scenario similar to that of FIG. 16 using a map-based user interface.

FIG. 18 illustrates a dynamic table showing current locations of all smartphones and officer devices.

FIG. 19 illustrates a partial exemplary flow of the safetalk-connect application.

FIG. 20 illustrates a partial exemplary flow of the webhost application.

FIG. 21 illustrates a partial exemplary flow of the server.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures.

Throughout this description, end-users (e.g., motorists, vehicle occupants, pedestrians) will have a processor-based device that is preloaded with an application, referred to as safetalk connect. Although any device is anticipated (e.g., personal computer, tablet computer, smartwatch), throughout this document, this device will be referred to as a smartphone as this is a typical device used by many end-users.

Throughout this description, each law enforcement vehicle, road ranger, or officer will also have a processor-based device (e.g., smartphone, tablet computer, personal computer) which will be referred to as the officer-device. The officer device will have preloaded software that will be referred to as the webhost application throughout this document.

Again, it is noted that the scenarios and devices described are related to people that are in motor vehicles (e.g., the end user is a motorist, and the officer is in a police car). This is for clarity and brevity reasons as many other scenarios are anticipated such as an officer that is walking and an end-user that is also walking. Further, the scenarios and devices described are related to an officer coming upon a motorist, either during a traffic stop or approaching a disabled vehicle. This application is not limited in any way to use only by motorists and officers as many other scenarios are anticipated, for example, an end-user coming within a certain distance of an establishment (e.g., approaching a fast food takeout window) in which the end-user's smartphone will receive a call from the order taker when their turn arises.

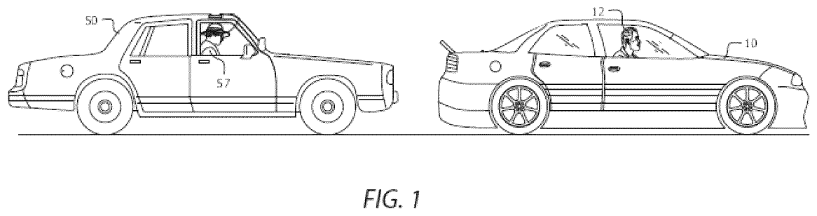

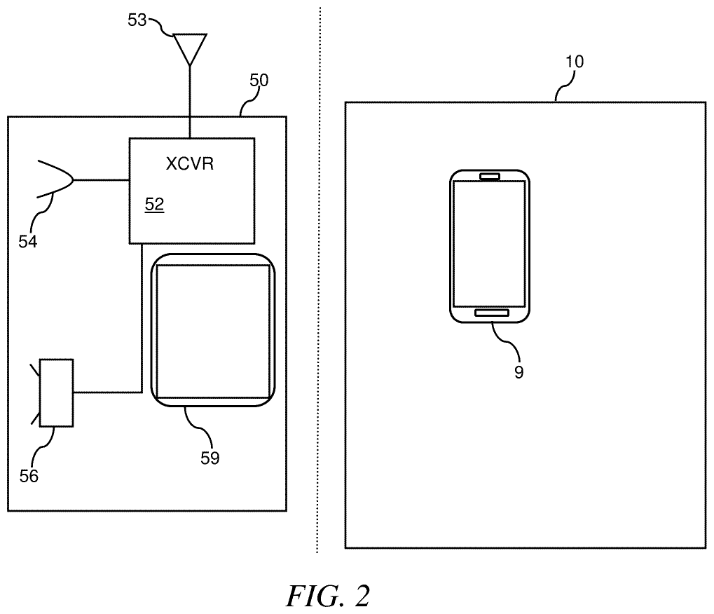

Referring to FIG. 1, a perspective view of a system for communicating between an official 57 and a end-user 12 will be described. The system for communicating between an official 57 and a end-user 12 is anticipated to be used when a end-user 12 in a vehicle 10 requests assistance and an official 57 in an official vehicle 50 (e.g., police or road ranger) is dispatched for assistance, for example, by a dispatcher at a call center 81 (see FIG. 2). In the example shown in FIG. 1, the response vehicle 50 is shown as a law-enforcement vehicle as an example of an official vehicle 50, though other types of responder vehicles 50 are equally anticipated such as tow trucks, road warriors, etc.

Prior to the present invention, during travel to the location of the end-user 12, the official 57 had limited or no communication with the end-user 12. Having no communications with the end-user 12, the official 57 is unable to assess the situation and is unable to comfort the end-user 12 with arrival information and status.

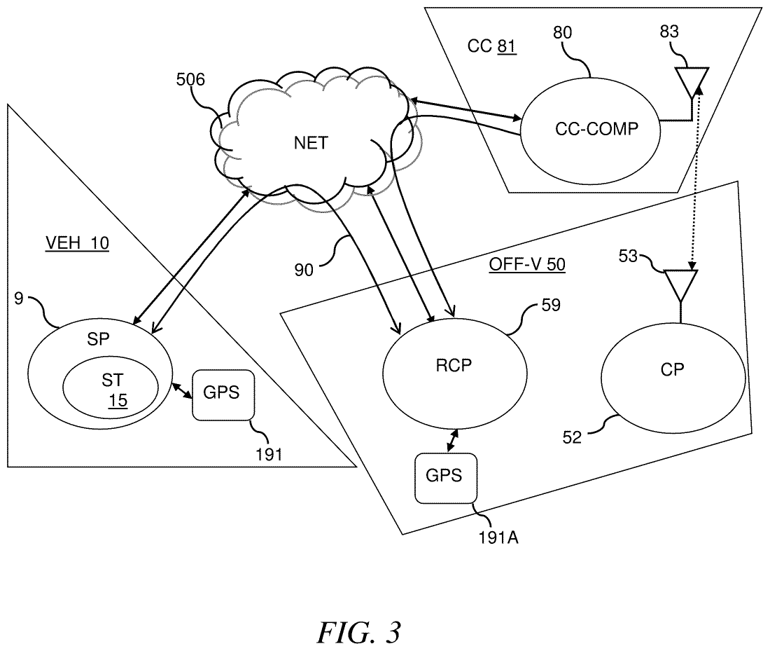

Referring to FIG. 2, communication equipment in vehicles of the system for communicating between an official 57 and a end-user 12 is shown. In general, the end-user 12 has a smartphone 9 (e.g., a cellphone or smartphone) that is capable of making calls (e.g., the emergency call) and installing and running a safetalk-connect application 15 (see FIG. 3). Today, most caller devices 9 have data capabilities (e.g., a smartphone) and are able to make voice connections using a data transport, for example, using voice over internet protocol connections (VOIP) or using any wireless system (e.g., wireless vehicle communication systems). In most situations, the official 57 has a officer device 59 (for example, a tablet computer or a smartphone) and often a vehicular radio that has a transceiver 52 with antenna 53, a microphone 54 and audio transducer 56. Often, the official 57 communicates with the call center 81 using the vehicular radio over dedicated communications wavelengths. In most embodiments, the officer device 59 has a display, processor, audio sensor (e.g., a microphone), and an audio transducer (e.g., speaker or headphone).

Prior to the system for communicating between an official 57 and a end-user 12, the officer device 59 was not used to communicate with the smartphone 9 due to privacy concerns and, for some configurations, the officer device 59 did not have the ability to make phone calls, for example, to make a phone call to the smartphone 9 over the cellular network. For example, if the officer device 59 is a tablet computer that is connected to the call center computer 80 through a data network, in the past, the officer device 59 receives/sends data to the call center computer 80 over that network, but even though many tablet computers have a speaker and microphone, they were not used to convey audio messages or make phone calls to the smartphone 9 as such would divulge addressing information such as an IP address and/or a phone number associated with the officer device 59.

Referring to FIG. 3, communications between the official 57 in an official vehicle 50 and end-user 12 in a vehicle 10 are shown communicating by way of the system for communicating with an occupant of a vehicle.

As in the past, the call center 81 (e.g., road assistance call center, call center for 911 calls) communicates either directly or indirectly with the official vehicle 50 (and official 57) by a two-way radio between antenna 83/53 or any other way known in the art. Note that the communications between the call center computer 80 and the official vehicle 50 are typically trusted, typically encrypted, whereas communications with the vehicle 10 are not generally trusted and, therefore, it is desired to not convey any connection data of the official vehicle 50 (officer device 59) with the vehicle 10 such as a phone number or address of any device associated with the official vehicle 50 or the responder for privacy and security reasons.

In the past, the end-user 12 made a call for assistance using the smartphone 9 in possession of the end-user 12 (e.g., through the cellular network 506 including the cellular network). The call for assistance is answered, for example, by a dispatcher in the call center 81 and the call center 81 dispatches the official 57, for example, through the two-way radio between antenna 83/53. In the past, there was no voice communications established directly between the official 57 and the end-user 12.

In the present disclosed system, the safetalk-connect application 15 is either previously installed on the smartphone 9 or installed under direction of the dispatcher by, for example, verbal instructions from the dispatcher or the dispatcher sending a download link to the smartphone 9. The call center computer 80 connects with the safetalk-connect application 15 running on the smartphone 9 of the end-user 12 (e.g., through the cellular network 506 which, in some embodiments, includes the Internet and/or cellular network). The safetalk-connect application 15 has voice over data capabilities, for example, voice-over-IP connection capabilities. After the safetalk-connect application 15 is ready, the call center computer 80 connects an application running on the officer device 59 (e.g., through the cellular network 506 or a private data network) to the safetalk-connect application 15 running on the smartphone 9 through a connection 90. Once the connection 90 is established, a voice connection (e.g., voice-over-IP) is established between the smartphone 9 and the officer device 59, without divulging identifying information of either the smartphone 9 or identifying information of the officer device 59 to the other party. Therefore, after the situation is corrected or after the responder reaches the caller, the voice-over-IP connection is terminated and neither party has knowledge of any addressing information of the other party (e.g., IP address or phone number). Privacy is maintained of both the caller and the responder as neither party has knowledge of the other party's phone number or any identifying information, therefore preserving privacy of both parties.

In one scenario of usage of the system for communicating between an official 57 and a end-user 12, when a stranded motorist calls 911 (e.g., the call center 81), the 911 operator will, in some embodiments, confirm the phone number of the end-user 12 and send the end-user 12 (e.g., the stranded motorist) information for installing the safetalk-connect application 15 on the smartphone 9 of the end-user 12. In some embodiments, the safetalk-connect application 15 is pre-installed on the smartphone 9. After an official 57 is identified/selected, the call center computer 80 connects the safetalk-connect application 15 of the end-user 12 with an application running on the officer device 59, allowing voice communications between the end-user 12 and the official 57 without disclosing the phone number of the end-user 12 to the official 57 and without disclosing any addressing information of the officer device 59 to the end-user 12.

In some embodiments, location information is read from a location device such as a global positioning subsystem 191/191A and the location information is exchanged with the call center computer 80 over a connection between the safetalk-connect application 15 and the call center computer 80 or between the officer device 59 and the call center computer 80. This location information provides accurate location information of the end-user 12 to the official 57 and/or provides an updated location (or estimated time of arrival) of the responder to the end-user 12 so that the caller can see how far the official 57 is from the end-user 12.

In some embodiments, the safetalk-connect application 15 utilizes local location information (e.g., from global positioning subsystem 191) to determine the closest call center 81, making a call (phone call or voice over data call) to the closest call center 81).

In another scenario for usage of the system for communicating between an official 57 and a end-user 12, when a stranded motorist (end-user 12) calls 911 (e.g., the call center 81) using the smartphone 9, the dispatcher will, in some embodiments, confirm the phone number of the smartphone 9 and connect the call center computer 80 to the safetalk-connect application 15 running on the smartphone 9. As most caller devices 9 have location reading systems such as global positioning subsystem 191, the safetalk-connect application 15 will read location information from a global positioning subsystem 191 of the smartphone 9 and transmit the location information to the call center computer 80. Having the location information at the call center computer 80, the dispatcher can verify an accurate location of the vehicle 10 and, in some embodiments, relay the accurate location of the vehicle 10 to software running on the officer device 59 for display on a map on the display of the officer device 59, optionally including directions on the best route for the official 57 to take to reach the caller 10. In some embodiments, the call center computer connects the safetalk-connect application 15 running on the caller device 12 with the software running on the officer device 59 only when the official 57 is within a certain distance of the end-user 12, allowing voice communications between the end-user 12 and the official 57 only when the official vehicle 50 is close to the vehicle 10 and without disclosing the phone number of the end-user 12 to the official 57 and without disclosing any addressing information of the officer device 59 to the end-user 12.

In some embodiments, the officer device 59 also has a global positioning subsystem 191A (e.g., GPS) and the location of the official 57 is periodically transmitted to the call center computer 80 (or to the safetalk-connect application 15 running on the smartphone 9). Having location information of the official 57, in some embodiments, the call center computer 80 periodically transmits the location information and/or estimated time-of-arrival of the official 57 to the caller device 12, where the safetalk-connect application 15 receives the location information of the official vehicle 50 and displays status information of the official 57, for example, estimated time-of-arrival, distance from the vehicle 10, and/or a map showing the route and/or progress of the official 57.

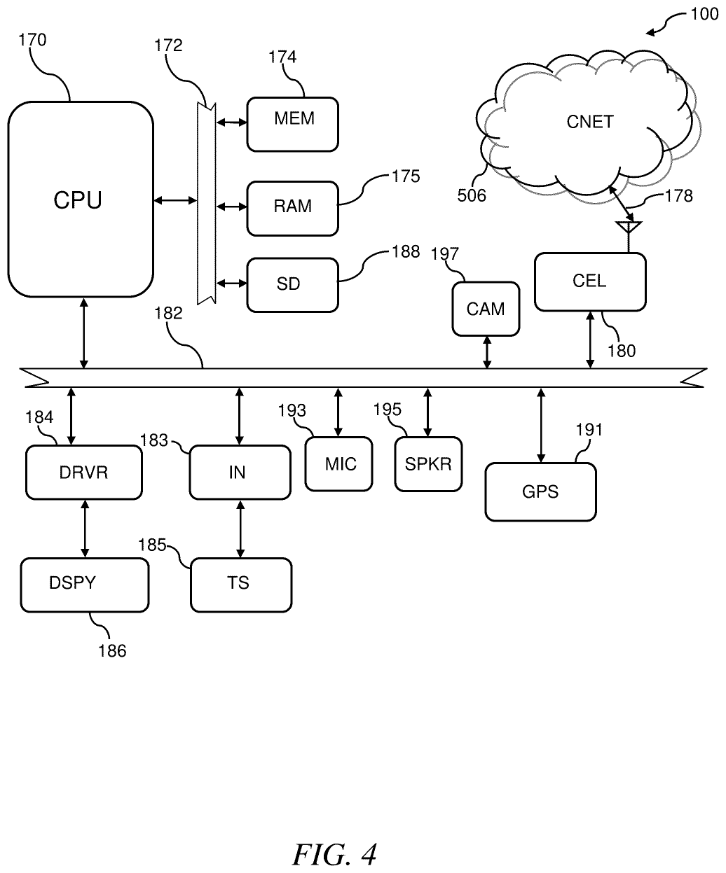

Referring to FIG. 4, a block diagram of an exemplary device 100 used as the smartphone 9 and/or the officer device 59. The device 100 is a processor-based device for providing communications and processing, for example, a smartphone or tablet computer. The present invention is in no way limited to any particular device 100 and many other devices are anticipated.

The exemplary device 100 represents a typical device used for voice communications and for accessing user interfaces of the system for communicating with an occupant of a vehicle. This exemplary device 100 is shown in its simplest form. Different architectures are known that accomplish similar results in a similar fashion, and the present invention is not limited in any way to any particular system architecture or implementation. In this exemplary device 100, a processor 170 executes or runs programs in a random-access memory 175. The programs are generally stored within a persistent memory 174 and loaded into the random-access memory 75 when needed. In some cellular enabled devices 100, a subscriber identification module 188 (e.g., SIM) provides calling information to the cellular network 506. The processor 170 is any processor, typically a processor designed for phones. The persistent memory 174, random-access memory 175, and removable storage slot are connected to the processor by, for example, a memory bus 172. The random-access memory 175 is any memory suitable for connection and operation with the processor 170, such as SRAM, DRAM, SDRAM, RDRAM, DDR, DDR-2, etc. The persistent memory 174 is any type, configuration, capacity of memory suitable for persistently storing data, for example, flash memory, read only memory, battery-backed memory, etc. In some agent computers 10, the persistent memory 174 is removable, in the form of a memory card of appropriate format such as SD (secure digital) cards, micro-SD cards, compact flash, etc.

Also connected to the processor 170 is a system bus 182 for connecting to peripheral subsystems such as a wireless network interface 180 (e.g., Cellular or Wi-Fi), a display driver 184 for driving a display device 186, an input port 183 for reading touch inputs from a touch screen interface 185, an audio input device 193, an audio transducer 195, and a camera 197; though there is no restriction on types and configurations of inputs and outputs.

In general, some portion of the persistent memory 174 is used to store executable code, and data, etc.

The peripherals are examples, and other devices are known in the industry such as a global positioning subsystem 191, the details of which are not shown for brevity and clarity reasons.

The wireless network interface 180 connects the device 100 to the cellular network 506 through any known or future protocol such as Ethernet, WI-FI, GSM, TDMA, LTE, etc., through a wired or wireless medium 178. There is no limitation on the type of connection used. The wireless network interface 180 provides data and messaging connections between the device 100 and, for example, the call center computer 80 through the cellular network 506.

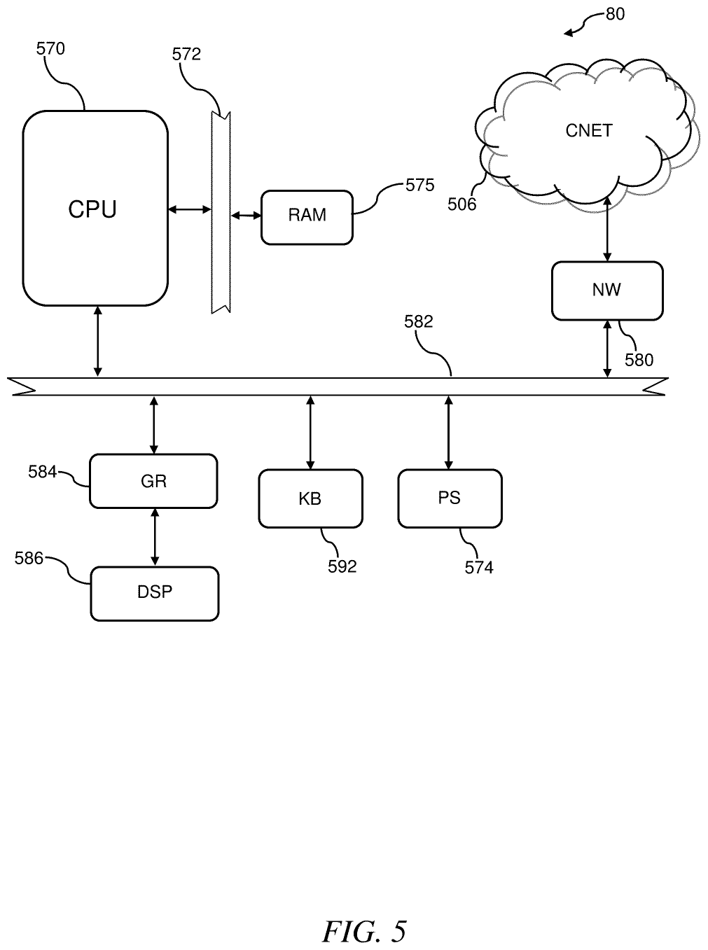

Referring to FIG. 5, an exemplary call center computer 80 as used by the system for communicating with an occupant of a vehicle is shown. The example call center computer 80 represents a typical computer system. This exemplary call center computer 80 (or server) is shown in its simplest form. Different architectures are known that accomplish similar results in a similar fashion and the present invention is not limited in any way to any particular computer system architecture or implementation. In this exemplary call center computer 80, a processor 570 executes or runs programs in a random-access memory 575. The programs are generally stored within a persistent memory 574 and loaded into the random-access memory 575 when needed. The processor 570 is any processor, typically a processor designed for computer systems with any number of core processing elements, etc. The random-access memory 575 is connected to the processor by, for example, a memory bus 572. The random-access memory 575 is any memory suitable for connection and operation with the processor 570, such as SRAM, DRAM, SDRAM, RDRAM, DDR, DDR-2, etc. The persistent memory 574 is any type, configuration, capacity of memory suitable for persistently storing data, for example, magnetic storage, flash memory, read only memory, battery-backed memory, etc. The persistent memory 574 is typically interfaced to the processor 570 through a system bus 582, or any other interface as known in the industry.

Also shown connected to the system bus 582 is a network interface 580 (e.g., for connecting to a cellular network 506), a graphics adapter 584 and a keyboard interface 592 (e.g., Universal Serial Bus-USB). The graphics adapter 584 receives information from the processor 570 and controls what is depicted on a display 586. The keyboard interface 592 provides navigation, data entry, and selection features.

In general, some portion of the persistent memory 574 is used to store programs, executable code, data, contacts, and other data, etc.

The peripherals are examples and other devices are known in the industry such as pointing devices, touch-screen interfaces, speakers, microphones, USB interfaces, Bluetooth transceivers, Wi-Fi transceivers, image sensors, temperature sensors, etc., the details of which are not shown for brevity and clarity reasons.

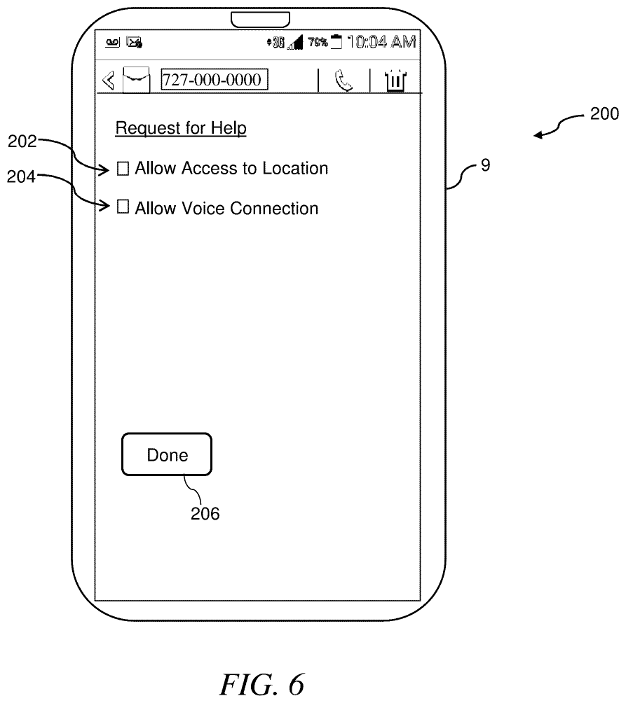

Referring to FIGS. 6-8, exemplary user interfaces of the system for communicating between an official 57 and a end-user 12 are shown. The user interfaces 200/220/240 are samples and in no way restrict the disclosed invention. The exemplary first user interface 200 (see FIG. 6) is presented by the safetalk-connect application 15 after the end-user 12 requests help from the call center 81. A dispatcher at the call center 81 requests information from the end-user 12 (e.g., name, identifying information, type of trouble or emergency, location) and starts initiation of an official 57 who will travel to the location of the end-user 12. The dispatcher enters information into the call center computer 80 and the call center computer 80 communicates with the safetalk-connect application 15 running on the smartphone 9. In this example, the safetalk-connect application 15 displays the exemplary first user interface 200 requests permission to allow access to location data 202 (e.g., from a global positioning subsystem 191 of the smartphone 9) and to allow a voice connection with the officer device 59. After selecting done 206, if access to location data 202 is allowed, the safetalk-connect application 15 reads the global positioning subsystem 191 of the smartphone 9 and transmits the location data to the call center computer 80 for more accurate pinpointing of the end-user 12. If a voice connection 204 is allowed, the safetalk-connect application 15 informs the call center computer 80 and the call center computer 80 creates a voice connection (e.g., voice over IP) between the safetalk-connect application 15 and the officer device 59, either directly or through the call center computer 80. After making selections, a “done” directive 206 is activated. Note that any user interface is anticipated and, in some embodiments, instead of requiring accepting permissions each usage, permission is provided by way of profile settings, etc.

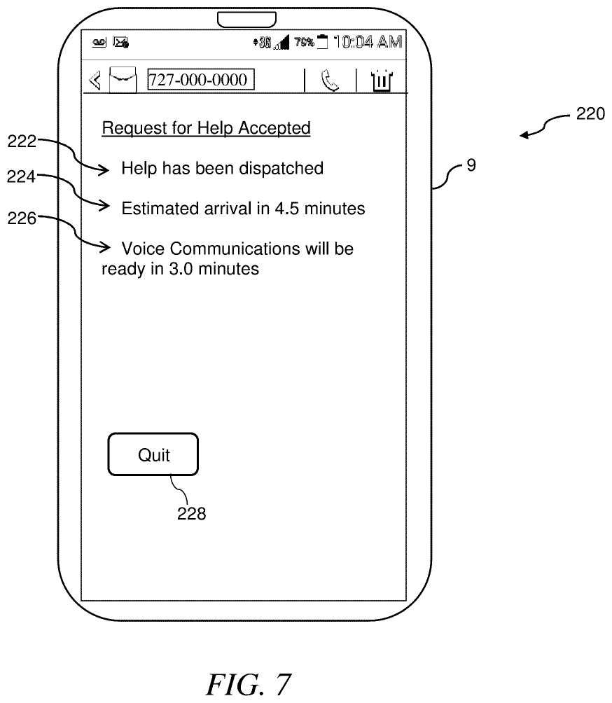

The exemplary second user interface 220 (see FIG. 7) is presented by the safetalk-connect application 15 while the official vehicle 50 is enroute to the vehicle 10. The exemplary second user interface 220 provides assurance and arrival information to the end-user 12 regarding arrival time of the official 57. In this example, an informational message 222 is displayed (e.g., “help has been dispatched”), though any message is anticipated. Also in this example, an estimated time of arrival 224 is displayed. The estimated time of arrival 224 is either based upon an initial estimate or the estimated time of arrival 224 is periodically updated with data transmitted from the call center computer 80, either as updated by the dispatcher or updated based upon location information received by the call center computer 80 from the global positioning subsystem 191A of the officer device 59. In some embodiments, voice communications are not enabled until the official vehicle 50 is within a certain distance from the vehicle 10. In such embodiments, a message indicating the estimated time until voice communications will be available 226 is also displayed. For completeness, a “quit” option 228 is available.

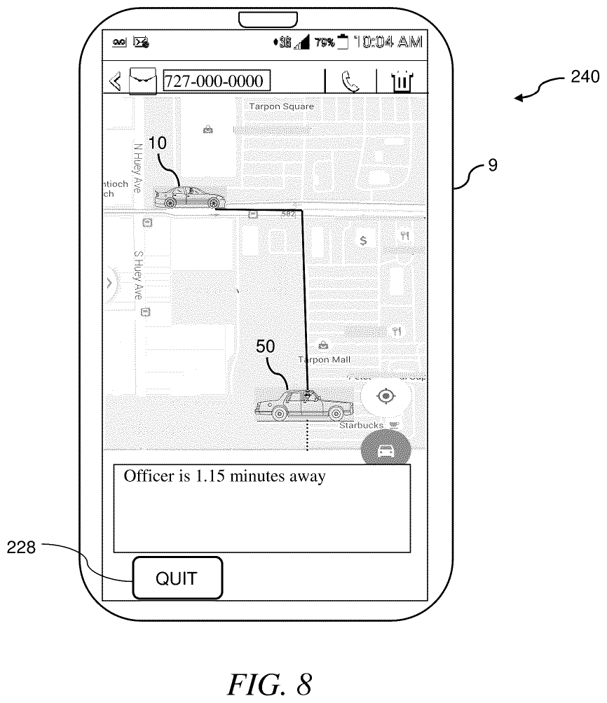

The third exemplary user interface 240 (see FIG. 8) is presented by the safetalk-connect application 15 while the official vehicle 50 is enroute to the vehicle 10. The third exemplary user interface 240 provides map-based information to the end-user 12 regarding arrival of the official 57. In this example, the current location of the official vehicle 50 is graphically displayed with route information showing the route to the vehicle 10. The current location of the official vehicle 50 is derived either as updated by the dispatcher or updated based upon location information received by the call center computer 80 from the global positioning subsystem 191A of the officer device 59. For example, software running on the officer device 59 periodically reads the global positioning subsystem 191A of the officer device 59 and transmits the location to the call center computer 80 and the call center computer either calculates an updated estimated time of arrival and transmits the updated estimated time of arrival to the safetalk-connect application 15 running on the smartphone 9 or transmits this location information to the safetalk-connect application 15 running on the smartphone 9 for displaying the location and/or process of the official 57. Again, for completeness, a “quit” option 228 is available.

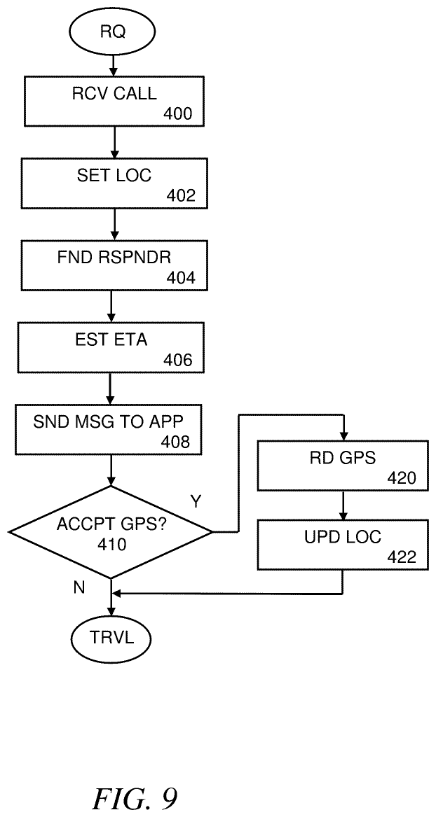

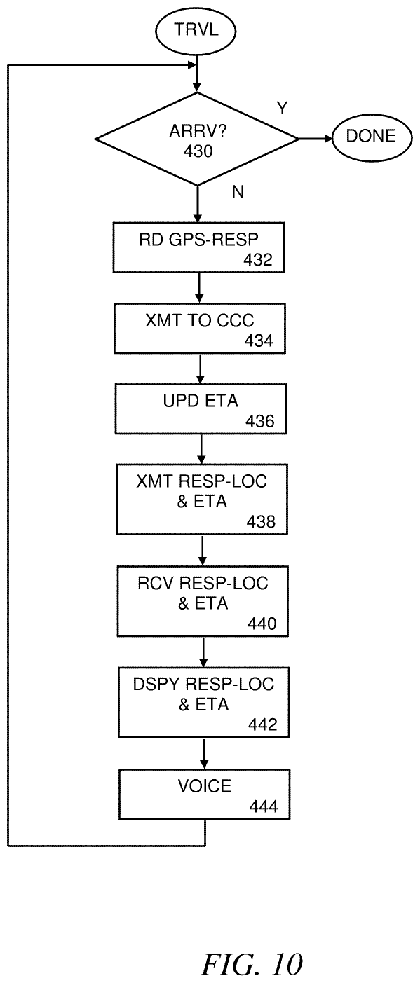

FIGS. 9 and 10 illustrate sample program flows of the system for communicating between an official 57 and a end-user 12. In FIG. 9, a request for help is received 400. The dispatcher sets a location 402 of the end-user 12 based upon questions asked (e.g., “where is the accident”) and then finds a responder 404 (e.g., an officer, tow truck, and/or road warrior). Based upon the location of the official 57, the dispatcher and/or the call center computer 80 calculates an ETA 406 (estimated time of arrival). Now information is sent to an application 408 that is running on the caller device 12 (e.g., to the safetalk-connect application 15). The application either has preprogrammed parameters providing approval for access to location data and/or for establishing a voice connection to the caller device 12. If access to location data 410 is approved, the application (e.g., safetalk-connect application 15) reads 420 the global positioning subsystem 191 of the caller device 12 and sends the location data to the call center computer 80 where the location is updated 422 to this more accurate location information.

In FIG. 10, the official vehicle 50 is traveling to the vehicle 10. During this travel, when the official vehicle 50 arrives 430 at the vehicle 10, the process completes. Until then, a loop repeats. Software of the system reads 432 the global positioning subsystem 191A of the officer device 59 to obtain a location of the official vehicle 50 and transmits 434 this location to the call center computer 80 (or directly to the safetalk-connect application 15 running on the caller device 12). The estimated time of arrival is updated 436, either by the call center computer 80 or the safetalk-connect application 15 running on the caller device 12. The location of the official vehicle 50 is transmitted 438 to the caller device 12. Upon reception 440 of the location of the official vehicle 50 at the caller device 12, the safetalk-connect application 15 displays 442 the location of the official vehicle 50 and/or an updated estimated time of arrival. During the loop, voice communications 444 are provided between the caller device 12 and the officer device 59, for example, for the official 57 to obtain more details of the issue/accident and for the end-user 12 to receive assurance from the official 57.

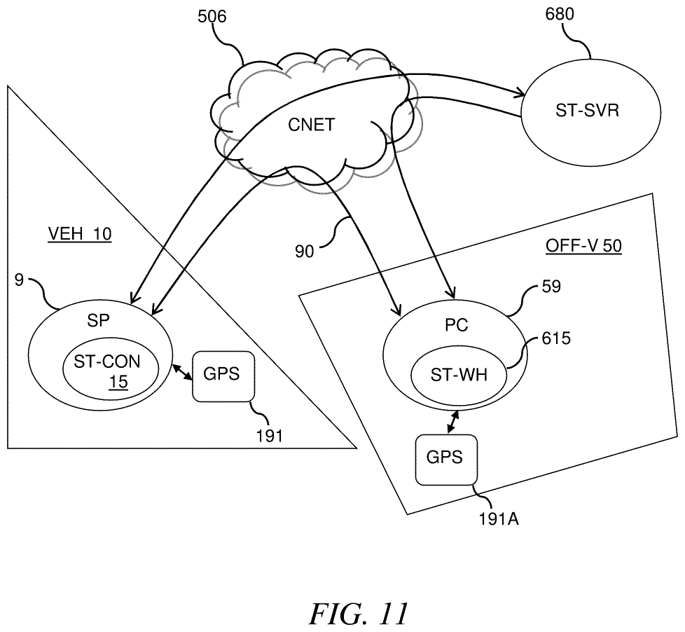

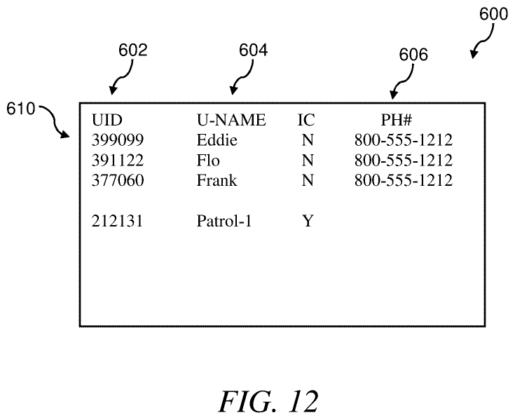

Referring to FIGS. 11 and 12, communications between the official 57 in an official vehicle 50 and an end user 12, for example, in a vehicle 10, are shown communicating by way of the system for communicating with an occupant of a vehicle.

In this embodiment, the safetalk-connect application 15 is installed on the smartphone 9 and configured. When the end-user 12 installs the safetalk-connect application 15 on the smartphone 9, part of the configuration process is to provide the end-user's telephone number and name or nickname. In some embodiments, the end-user's telephone number is entered directly into a user interface during this configuration while, in some embodiments, the end-user's telephone number is read directly from the subscriber identification module 188 of the smartphone 9.

Software running on the safetalk server 680 allocates an end-user ID 602 and adds an entry 610 in the end-user table 600 (see FIG. 12) for that end-user 12 that includes the end-user ID 602, the end-user name 604 (or nickname), and the end-user's telephone number 606. For example, the first line of the end-user table 600 is for the end-user 12 whose end-user name 604 is “Eddie” and who is assigned an end-user ID 602 of 399099 and has an end-user telephone number 606 of “800-555-1212.” The end-user table 600 is kept secure and is not accessible by, for example, officers and road warriors, as the end-user telephone numbers 606 are private and not to be disclosed to unauthorized personnel. In some embodiments, the end-user table 600 is encrypted for security reasons.

After installation and configuration and while running on the smartphone 9, the safetalk-connect application 15 periodically reads the location of the smartphone 9 from the global positioning subsystem 191 of the smartphone 9 and connects with the safetalk server 680 (e.g., through the cellular network 506 or any wide-area network) to transmit the location to the safetalk server 680.

Further, in this embodiment, the webhost application 615 is installed on the officer device 59 and configured. As above, the officer device 59 has a global positioning subsystem 191A, a sound sensor 54 (e.g., a microphone) and a sound emitter 56 (e.g., a speaker or earphones). After installation and configuration and while the webhost application 615 is running on the officer device 59, the webhost application 615 periodically reads the officer's location (location of the officer device 59) from the global positioning subsystem 191 and connects with the safetalk server 680 (e.g., through the cellular network 506 or any wide-area network) to transmit the officer location to the safetalk server 680.

Note that for safetalk-connect application 15 and the webhost application 615, any method of periodically transmitting a location is anticipated, including, but not limited to the safetalk-connect application 15 setting a timer and when the timer expires, sending its location to the safetalk server 680 and the server setting a timer and when that timer expires, sending a request for the location to the safetalk-connect application 15.

The safetalk server 680, upon receiving locations of one or more safetalk-connect application 15 (e.g., smartphones 9) and one or more webhost application 615 (e.g., officer devices 59), software running on the safetalk server 680 compares locations of the smartphones 9 to locations of the officer devices 59 and when any of the smartphones 9 are within a preset (and configurable) distance from one of the officer devices 59, the safetalk server 680 transmits the location of the smartphone 9 to the webhost application 615 that is running on that officer device 59, where the end-user name 604 associated with the smartphone 9 that is within the preset distance to the officer device is displayed, for example, in a list or on a map. Next to the end-user name 604 will be options displayed (e.g., a phone icon and/or a video icon). Again, in some embodiments, the end-user telephone number 606 is not displayed for privacy reasons. Once within the preset distance and the end-user name 604 and options are displayed (e.g., a phone icon and/or a video icon), selecting one of the options initiates a call to the smartphone 9 that is associated with that end-user 12. In this, the webhost application 615 has access to the end-user telephone number 606 and initiates either a voice call or a video call using a VOIP system. The VOIP system initiates the call through the phone system and/or cellular network 506 using the end-user telephone number 606 and a connection to the smartphone 9 of this end-user 12 is attempted (e.g., the smartphone 9 rings). The caller-id that is displayed on the smartphone 9 is not a phone number of the officer/road ranger, but a name such as “Tampa Police Department” or “Road Rangers” so as not to provide calling information of the officer or road ranger to the end-user 12. Now the end-user 12 is able to answer the call and speak with the officer or road ranger without anybody exiting their vehicles and neither party has access to calling information of the other party, for privacy reasons.

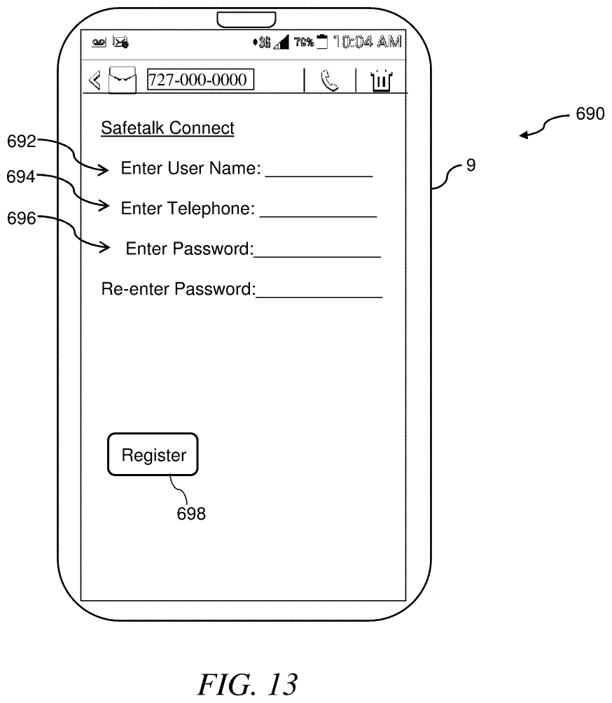

Referring to FIG. 13, an exemplary registration user interface 690 is shown. To register, the user enters a user name 692 (e.g., the name that the user will be known as and the login name for the user), their telephone number 694, and their password 696 (in some embodiments twice). For brevity and clarity reasons, it is assumed that the password 696 is checked and stored in a secure location of the safetalk server 680. Although a username and password are shown, any known method of verifying the user is anticipated. Further, other security mechanisms are fully anticipated, including verifying the telephone number 694 (e.g., sending an authorization code), two-factor authentication, etc. After entering the required information, the end-user 12 selects the “register” icon 698.

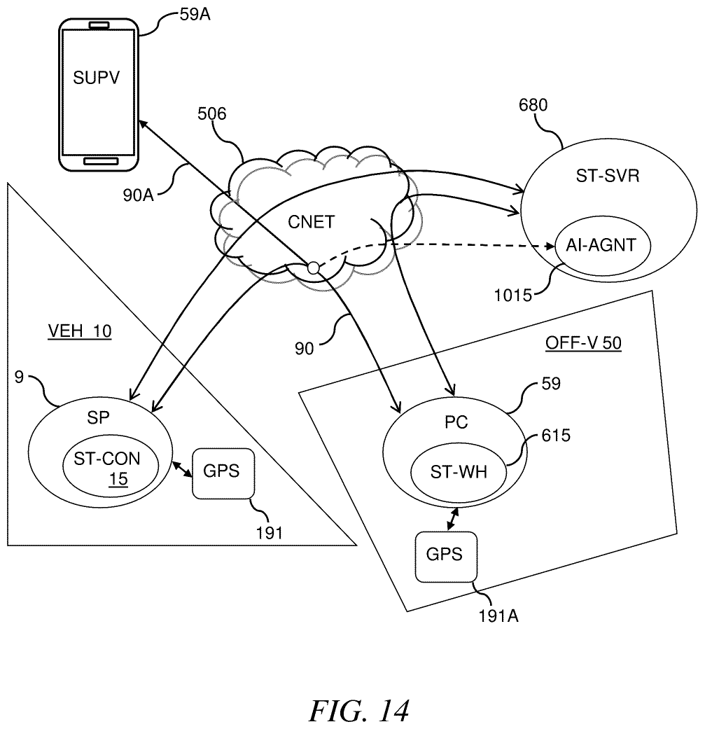

In the embodiment shown in FIG. 14, much of the same scenario of FIG. 12 is repeated with the safetalk-connect application 15 installed on the smartphone 9 and configured. The safetalk-connect application 15 periodically reads the location of the smartphone 9 from the global positioning subsystem 191 of the smartphone 9 and connects with the safetalk server 680 (e.g., through the cellular network 506 or any wide-area network) to transmit the location to the safetalk server 680.

The webhost application 615 is installed on the officer device 59 and configured. As above, the officer device 59 has a global positioning subsystem 191A, a sound sensor 54 (e.g., a microphone) and a sound emitter 56 (e.g., a speaker or earphones). After installation and configuration and while the webhost application 615 is running on the officer device 59, the webhost application 615 periodically reads the officer's location (location of the officer device 59) from the global positioning subsystem 191 and connects with the safetalk server 680 (e.g., through the cellular network 506 or any wide-area network) to transmit the officer location to the safetalk server 680.

As with the embodiment of FIG. 12, the end-user name 604 will have options displayed (e.g., a phone icon and/or a video icon). Once within the preset distance and the end-user name 604 and options are displayed (e.g., a phone icon and/or a video icon), selecting one of the options initiates a call to the smartphone 9 that is associated with that end-user 12. In this, the webhost application 615 has access to the end-user telephone number 606 and initiates either a voice call or a video call using a VOIP system. The VOIP system initiates the call through the phone system and/or cellular network 506 using the end-user telephone number 606 and a connection to the smartphone 9 of this end-user 12 is attempted (e.g., the smartphone 9 rings). The caller-id that is displayed on the smartphone 9 is not a phone number of the officer/road ranger, but a placeholder or similar such as an organization's name such as “Tampa Police Department” or “Road Rangers” so as not to provide calling information of the officer or road ranger to the end-user 12. Now the end-user 12 is able to answer the call and speak with the officer or road ranger without anybody exiting their vehicles and neither party has access to calling information of the other party, for privacy reasons. The main difference between FIG. 12 and FIG. 14 is the escalation path. FIG. 14 shows a supervisor's phone 59A. Should the end-user 12 required escalation of the issue, the officer will have an escalate option which will create a three-way conference call (adding a connection 90A to the supervisor's phone 59A) so that the end-user 12 is able to speak to both the officer and the supervisor, as needed.

Also shown in FIG. 14 is an artificial intelligence agent 1015. This artificial intelligence agent 1015 has the ability to monitor conversations between the officer, end-user 12, and supervisor for any or all of the following:
The artificial intelligence agent 1015 listens and records some or all conversations for analysis and training.
The artificial intelligence agent 1015 collects data from these calls. In some embodiments, names and phone numbers are redacted and used for training purposes.
The artificial intelligence agent 1015 integrates location data and uncovers trends in vehicle stops to provide policing data to police agencies.
The artificial intelligence agent 1015 uncovers bias or offensive sentiment or intentions on each call. In some embodiments, if certain bias or language is detected, the supervisor is added to the call.
The artificial intelligence agent 1015 securely stores a recording of the encounter for further analysis and training.

In some embodiments, the artificial intelligence agent 1015, using multi-modal AI technology, detects certain sounds within the vehicle such as the chambering of a round in a weapon and alerts the officer to possible dangerous scenarios while the officer is still within in his/her patrol car.

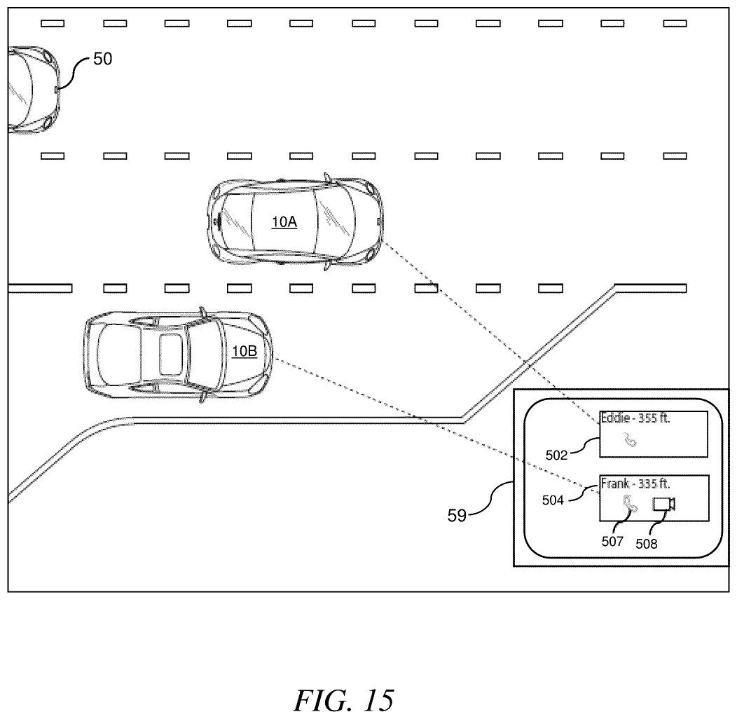

In the scenario of FIG. 15, an official vehicle 50 is within the preset distance (e.g., within 1000 feet) of two vehicles 10A/10B. Both vehicles 10A/10B have the safetalk-connect application 15 installed and running. Once within the preset distance, both vehicles 10A/10B are displayed on the display of the officer device 59 by the webhost application 615. One vehicle has an end-user 12 named Eddie 502 who is 335 feet from the official vehicle 50 and the other vehicle has an end-user 12 named Frank 504 who is also 335 feet from the official vehicle 50. If the officer or road warrior wishes to talk to either Eddie 502 or Frank 504, the officer or road warrior selects either the call icon 507 or video call icon 508. Responsive to selecting either icon 507/508, the phone number of the selected person is obtained by the webhost application 615 or is already present because it was previously stored by the webhost application 615. Now, the webhost application 615 initiates a voice over Internet protocol (VOIP) call (voice or voice/video) to that number. If the call goes through, the officer or road warrior is able to talk with the end-user 12, for example, to determine if the end-user 12 needs help.

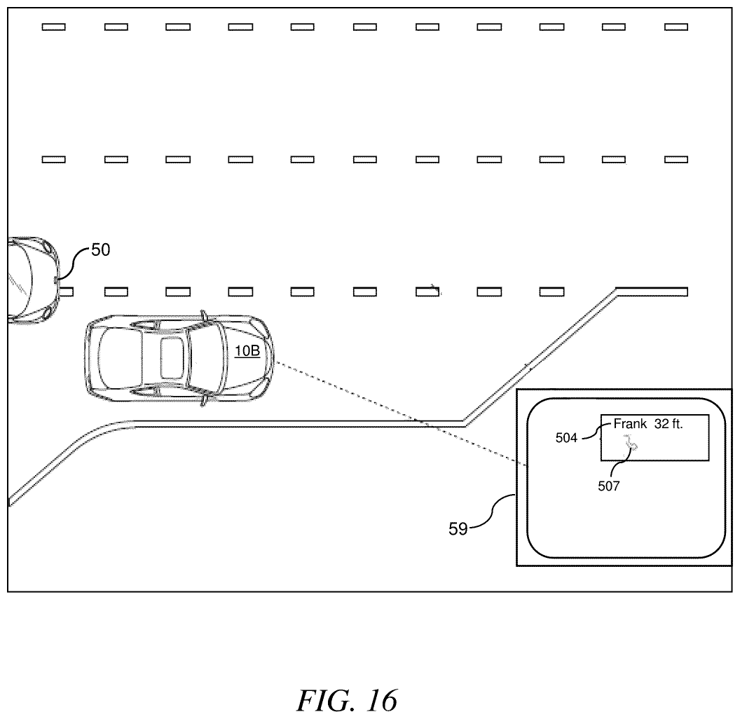

In the scenario of FIG. 16, an official vehicle 50 has pulled over a vehicle 10B for a traffic stop. Therefore, the vehicle 10B is within the preset distance (e.g., within 1000 feet). As the vehicle 10B has the safetalk-connect application 15 installed and running, the name of the end-user 12 named Frank 504 is displayed on the display of the officer device 59 by the webhost application 615. Now, the officer has the ability to talk to Frank 504 by selecting either the call icon 507 or video call icon 508. Responsive to selecting either icon 507/508, the phone number of the selected person is obtained by the webhost application 615 or is already present because it was previously stored by the webhost application 615. Now, the webhost application 615 initiates a voice over Internet protocol (VOIP) call (voice or voice/video) to that number. If the call goes through, the officer or road warrior is able to talk with Frank 504, for example, to explain what has happened. At any time, with the permission of the end-user 12, the officer can initiate a video session and will be able to see through the camera 197 of the smartphone 9. In this way, the officer can request that the end-user 12 show the occupants of the vehicle, show the officer the end-user's 12 (or driver's) driver's license, registration, and insurance card, etc. If the officer decides to issue a citation, the officer can complete the citation and approach the vehicle to present the ticket or send the citation electronically.

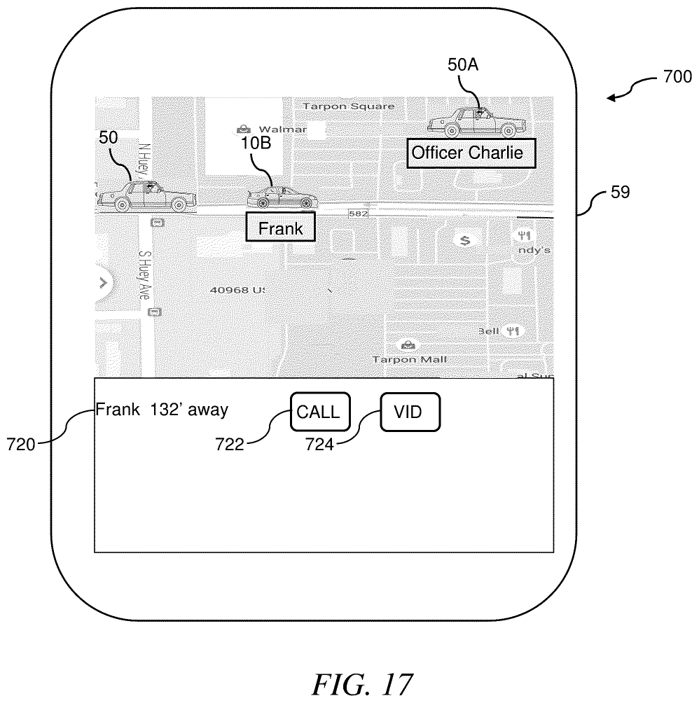

Referring to FIG. 17, a scenario similar to that of FIG. 16 is shown within a map-based user interface 700. An official vehicle 50 has pulled over a vehicle 10B for a traffic stop. Therefore, the vehicle 10B is within the preset distance (e.g., within 1000 feet of the official vehicle 50). As the vehicle 10B has the safetalk-connect application 15 installed and running, the name of the end-user 12 named Frank 720 is displayed on the display of the officer device 59 by the webhost application 615. Now, the officer has the ability to talk to Frank 720 by selecting either the call icon 722 or video call icon 724. Responsive to selecting either icon 722/724, the phone number of the selected person is obtained by the webhost application 615 or is already present because it was previously stored by the webhost application 615. Now, the webhost application 615 initiates a voice over Internet protocol (VOIP) call (voice or voice/video) to that number. If the call goes through, the officer or road warrior is able to talk with Frank 720, for example, to explain what has happened. At any time, with the permission of the end-user 12, the officer can initiate a video session and will be able to see through the camera 197 of the smartphone 9. In this way, the officer can request that the end-user 12 show the occupants of the vehicle, show the officer the end-user's 12 (or driver's) driver's license, registration, and insurance card, etc. If the officer decides to issue a citation, the officer can complete the citation and approach the vehicle to present the ticket or send the citation electronically. In this view, a second official vehicle 50A is also shown, as the second official vehicle 50A is within the preset distance (e.g., within 1000 feet of the official vehicle 50). In such, by indicating the location of other official vehicles, the officer has the ability to know which other officers are in the vicinity in case help is needed or to see progress during a high-speed chase, etc.

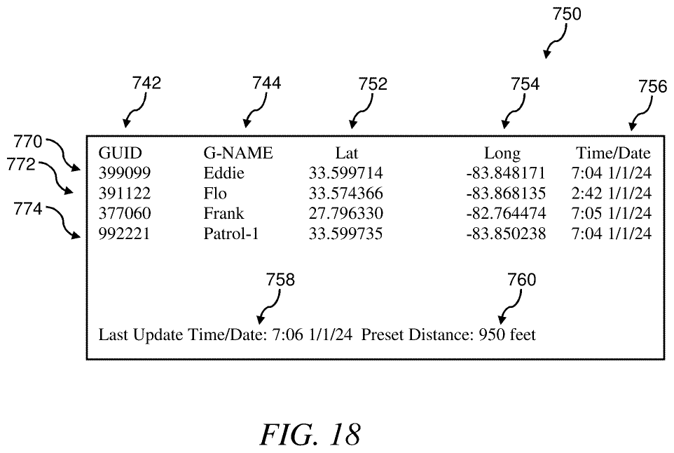

Referring to FIG. 18, a dynamic table 750 is shown. In some embodiments, the dynamic table 750 includes a last-update time 758 and the preset distance 760 (e.g., 950 feet).

The dynamic table 750 has entries for each user, both webhost users (those having webhost access through a webhost application 615) and end-users 12 (those having end-user access through a safetalk connect application 15). Each user has a user id 742 and a name 744 along with the user's most recent latitude 752 and longitude 754 and the time and date 756 that the latitude 752 and longitude 754 were reported. As discussed prior, periodically, each safetalk-connect application 15 and each webhost application 615 reads their associated global positioning subsystem 191/191A and transmits their location to the safetalk server 680. In the example of FIG. 18, the first entry 770 is for Eddie having a latitude/longitude of 33.599714,-83.848171 that was reported at 7:04 on Jan. 1, 2024. There is also an entry 772 is for Flo having a latitude/longitude of 33.574366,-83.868135 that was reported at 2:42 on Jan. 1, 2024. Note that since the current time is 7:06 on Jan. 1, 2024, the entry 772 for Flo is old and it is assumed that the smartphone 9 associated with Flo has been disabled or the safetalk application 15 has been disabled in some way as there have been no transmission of the location of this smartphone 9 for several hours.

The third entry 774 is for an officer, Patrol-1 and has a latitude/longitude of 33.599735,-83.850238 that was reported at 7:04 on Jan. 1, 2024.

The server periodically performs two-way comparisons between each user and each other user to determine which users are within the preset distance 760 of each other. There are well known algorithms for comparing two locations that take into account differences in the length of a second depending upon the latitude and longitude, though these algorithms typically depend on trigonometric functions. Therefore, as the number of users grows, the number of distance calculations will grow as well. To improve the performance of the two-way comparisons, it is anticipated that in some embodiments, several efficiency-improving algorithms are anticipated. For one, a simple subtraction of one component of the location (e.g., latitude) is performed and if the distance is greater than the preset distance 760, then there is no need to perform the actual distance calculation as any difference in the other component only results in a greater distance, so the location difference has to be greater than the preset distance 760. Another efficiency-improving algorithm involves clustering of users and creating dynamic tables 750, each for certain geographic ranges. For example, one dynamic table might contain users within a geographic sub-range of 33.590000,-83.840000 to 33.600000,-83.850000. As it is understood that end-users 12 having safetalk-connect applications 15 will interface with any agency throughout the country and world, when a user is within a certain geographic sub-range, they will be compared with other users within the same geographic sub-range. When a user's location changes (e.g., exits a geographic sub-range and enters another geographic sub-range), the user information is deleted from the first geographic sub-range and added to the second geographic sub-range. In this way, a user in California is not compared to another user in Georgia as they will never be within the preset distance 760. Another efficiency-improving algorithm involves only comparing locations of end-users 12 with locations of officers/road warriors, as it is not important to know how far apart two end-users 12 are. In addition, in some such embodiments, the locations of officers/road warriors are also compared to determine officers/road warriors that are within the preset distance 760 of each other.

Note that, in some embodiments, when the time and date 756 of an entry indicates that the entry is old (e.g., location was not updated for many minutes, that entry is skipped as it is assumed that the associated safetalk-connect application 15 is incognito or disabled.

Outputs of the above algorithms provide, for each officer (e.g., webhost application 615 that is enabled), a list of end-users 12 that are within the preset distance 760 of that officer and in some embodiments, a list of other officers that are within the preset distance 760 of that officer. This list is transmitted to the webhost application 615 of that officer for display on the officer device 59, for example, in list format or in map format, as discussed above.

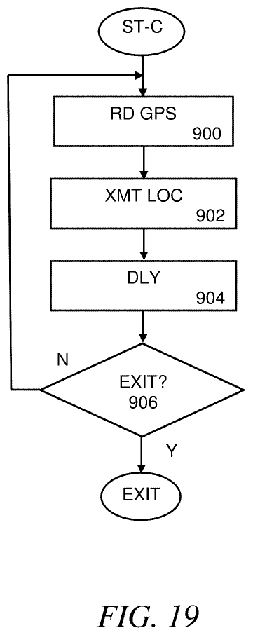

Referring to FIG. 19, a partial exemplary flow of the safetalk-connect application 15 is shown. In this, the safetalk-connect application 15 runs in a loop, reading 900 a location of the smartphone 9 (or other device as discussed above) from the global positioning subsystem 191 (GPS) of the smartphone 9 (or other device as discussed above) and transmitting 902 the location to the safetalk server 680. To limit the transmissions and amount of data, there is a delay 904 in the loop, for example five to ten seconds, or whatever is needed to control the amount of data transmitted while maintaining up-to-date locating data for each end-user 12. If the end-user 12 signals exit 906, the loop ends, otherwise the above steps are repeated.

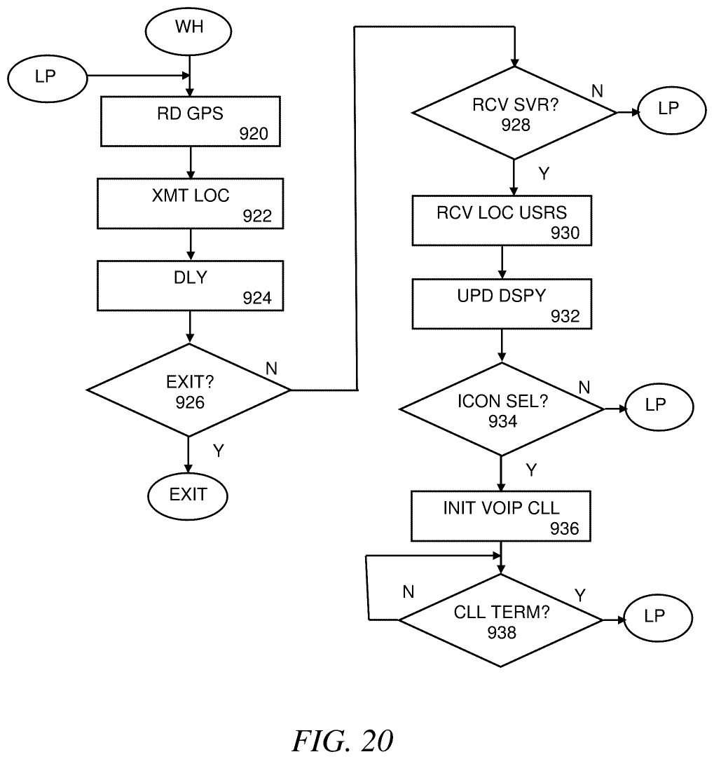

Referring to FIG. 20, a partial exemplary flow of the webhost application 615 is shown. In this, the webhost application 615 runs in a loop, reading 920 a location of the officer device 59 from the global positioning subsystem 191A (GPS) of the officer device 59 and transmitting 922 the location to the safetalk server 680. To limit the transmissions and amount of data, there is a delay 924 in the loop, for example five to ten seconds, or whatever is needed to control the amount of data transmitted while maintaining up-to-date locating data for each officer/road ranger. If the officer/road ranger signals exit 926, the loop ends, otherwise the webhost application 615 makes a test 928 to determine if data is ready from the safetalk server 680. If the test 928 to determine if data is ready indicates data is not ready, the above loop continues.

If the test 928 to determine if data is ready indicates data is ready, the locations of any end-users 12 within the preset distance is received 930 from the safetalk server 680 and the display of the officer device 59 is updated 932 (e.g., the location of the end-users 12 is displayed on a map and/or a list of the end-users 12 and their distance from the officer device 59 is displayed).

Next, another test 934 is made to determine if the officer/road warrior has selected an icon associated with one of the end-users 12 that are being displayed on the officer device 59 (e.g., the initiate call icon was selected by touch). If the officer/road warrior has not selected an icon associated with one of the end-users 12, the above is repeated. If the officer/road warrior has selected an icon associated with one of the end-users 12, the function for that icon is performed 936, in this example, a voice over Internet protocol (VOIP) call is made from the officer device 59 to the end-user 12 that is associated with the icon. When the call (or other function) terminates 938, the above loop continues.

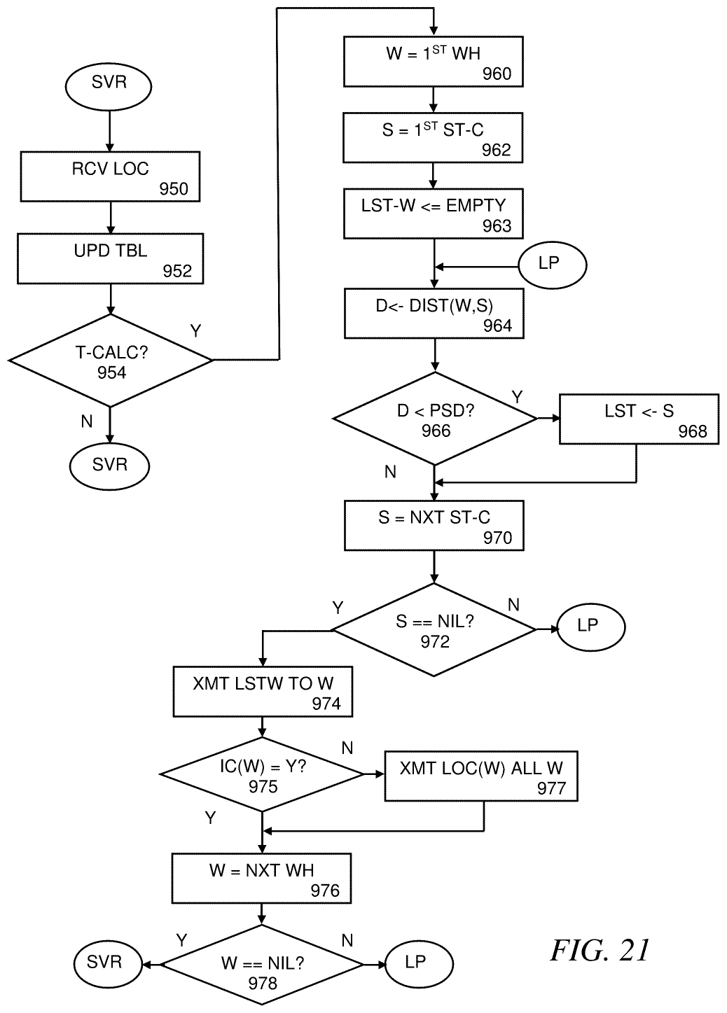

Referring to FIG. 21, a partial exemplary flow of the safetalk server 680 is shown. The server randomly receives locations 950 from safetalk-connect applications 15 and from webhost application 615 and updates 952 a table with these current locations for each. Periodically, the server determines when 954 it is time to perform distance calculations. If it is not time to perform distance calculations, the above repeats.

When it is time to perform distance calculations, pair-wise location comparisons are made between each officer device 59 and each smartphone 9 (or other device as discussed above). For example, the first active webhost application 615 from the table is selected 960 for W and the first active safetalk-connect application 15 from the table is selected 962 for S and a list is cleared 963. Next, in a sub-loop, LP, the location of W is compared to the location of S to determine the distance 964 between W and S (e.g., the distance between this officer device 59 and this smartphone 9). If 966 the distance between W and S is less than the preset distance (e.g., 1000 feet), S (information about this smartphone 9 and end-user 12) is added 968 to the list (e.g., the list for the current officer device 59).

Next, the next safetalk-connect application 15 (e.g., smartphone 9) is selected 970 as S. Now, if 972 S is not nil (e.g., there are more smartphones 9 to compare), the above (LP) is repeated.

If 927 S is nil (e.g., there are no more smartphones 9 to compare), the list for the current officer device 59 is transmitted 974 from the server to the current officer device 59 for reception by the webhost application 615. Now (in some embodiments) a test 975 is made to determine if this webhost application 615, W, is incognito (e.g., the location of this webhost is not to be disclosed). If the webhost application 615, W, is not incognito, then the location of this webhost application 615, W, is transmitted 977 to all other webhost applications 615.

The next webhost application 615 (e.g., officer device 59) is selected 976 as W. Now, if 978 W is not nil (e.g., there are more officer devices 59 to compare), the above (LP) is repeated for this officer device 59 or webhost application 615.

Note that in some embodiments, the location of one or more webhosts 615, and hence, officer devices 59, is transmitted to one or more safetalk-connect applications 15 for display on a user interface that is generated by the safetalk-connect application 15, for example as a position on a map or as a distance (e.g., officer xxx is 50 feet away).

Otherwise, if 978 W is nil, the pair-wise comparisons are complete and the entire process repeats from the top (SVR).

Equivalent elements can be substituted for the ones set forth above such that they perform in substantially the same manner in substantially the same way for achieving substantially the same result.

It is believed that the system and method as described and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. A system for communicating between an official and an end-user comprising:
an officer device associated with the official, the officer device having a processor, a display, a memory, a global positioning subsystem, and a first network interface for connecting to a wide area network;
an end-user device having an end-user processor, an end-user display, a second network interface for connecting to the wide area network, an end-user global positioning subsystem, and an end-user memory, a safetalk-connect application installed in the end-user memory;
a safetalk server computer having a server processor, server memory, and a third network interface for connecting to the wide area network;
periodically, a webhost application running on the officer device reads the global positioning subsystem and transmits a location of the officer device to the safetalk server computer over the wide-area network;
periodically, the safetalk-connect application running on the end-user device reads the end-user global positioning subsystem and transmits the location of the end-user device to the safetalk server computer over the wide-area network;
when the safetalk server computer receives the location from either the officer device or the end-user device, software running on the safetalk server computer adds a record to a table of locations; and
periodically, the safetalk server computer calculates a distance between the officer device and the end-user devices and for each end-user device that is within a preset distance from the officer device, the location of the end-user device is displayed on the display of the officer device.

2. The system of claim 1, wherein when the location of the end-user device is displayed on the display, a call directive is associated with the location of the end-user device and when the call directive is invoked, a phone number of the end-user device is retrieved and a voice over internet protocol call is made from the officer device to the end-user device.

3. The system of claim 1, wherein when the location of the end-user device is displayed on the display, a video-call directive is associated with the location of the end-user device and when the video-call directive is invoked, a phone number of the end-user device is retrieved and a video call is made from the officer device to the end-user device.

4. The system of claim 1, wherein the end-user device is a smartphone.

5. The system of claim 1, wherein the end-user device is a dash-cam.

6. The system of claim 1, wherein the preset distance is 1000 feet.

7. A system for communicating between officials and end-users comprising:
a plurality of officer devices, each officer device associated with one of the officials, each of the officer devices having a processor, a display, a memory, a global positioning subsystem, and a first network interface for connecting to a wide area network;
a plurality of end-user devices, each end-user device of the plurality of end-user devices having an end-user processor, an end-user display, a second network interface for connecting to the wide area network, an end-user global positioning subsystem, and an end-user memory with a safetalk-connect application installed in the end-user memory and running on the end-user processor;
a safetalk server computer having a server processor, server memory, and a third network interface for connecting to the wide area network;
periodically, a webhost application running on each of the officer devices reads the global positioning subsystem and transmits a location of the officer device to the safetalk server computer over the wide area network;
periodically, the safetalk-connect application running on each of the end-user devices reads the end-user global positioning subsystem and transmits the location of the end-user device to the safetalk server computer over the wide area network;
when the safetalk server computer receives the location from either the officer device or the end-user device from the wide area network, software running on the safetalk server computer adds a record to a table of locations; and
periodically, for each officer device of the officer devices, software running on the server processor calculates a distance between the each officer device and each of the end-user devices and for each end-user device that is within a preset distance from the officer device, the location of the each end-user device is saved in a list and the list is transmitted from the safetalk server computer to the each officer device over the wide area network and displayed on the display of the each officer device.

8. The system of claim 7, wherein when the location of the end-user device is displayed on the display, a call directive is associated with the location of the end-user device and when the call directive is invoked, a phone number of the end-user device is retrieved and a voice over internet protocol call is made from the officer device to the end-user device that is associated with the phone number.

9. The system of claim 7, wherein when the location of the end-user device is displayed on the display, a video-call directive is associated with the location of the end-user device and when the video-call directive is invoked, a phone number of the end-user device is retrieved and a video call is made from the officer device to the end-user device that is associated with the phone number.

10. The system of claim 7, wherein the end-user device is a smartphone.

11. The system of claim 7, wherein the end-user device is a dash-cam.

12. The system of claim 7, wherein the preset distance is 1000 feet.

13. A method for communicating between an official and an end-user, the method comprising:
means for determining when any end-user is within a preset distance of the official;
means for displaying each of the any end-users that is/are within the preset distance of the official on a display that is visible to the official; and
means for initiating a call from the official to any one of the any end-users that is/are within the preset distance of the official.

14. The method of claim 13, wherein the preset distance is 1000 feet.

15. The method of claim 13, wherein the means for determining when any end-user is within the preset distance of the official comprises, for each official, performing a pair-wise calculation of a distance between the official and each end-user and when the distance between the official and the each end-user is less then the preset distance, adding the each end-user to a list, and after a last end-user, sending the list to the official over a network and receiving the list at a device of the official and displaying the list on the display of the device for reading by the official.

16. The method of claim 15, wherein when displaying the list on the display of the device, displaying the list in map format.

17. The method of claim 15, wherein the means for initiating the call from the official to any one of the any end-users that is/are within the preset distance of the official comprises the official selecting a call-icon associated with the end-user causing a voice over internet protocol phone call to be made between the device of the official and a second device of the end-user.

18. The method of claim 17, wherein the second device is a smartphone.

19. The method of claim 17, wherein the second device is a dash-cam.
